(19) United States
(12) Patent Application Publication
(10) Pub. No.: US 2019/0203837 A1
(43) Pub. Date: Jul. 4, 2019

(54) SEAL

(71) Applicant: Eaton Intelligent Power Limited, Dublin 4 (IE)

(72) Inventors: Benjamin CANN, Karlsruhe (DE); Bert LEISENHEIMER, Rastatt (DE); Christophe SCHORSCH, La Wantzenau (FR)

(21) Appl. No.: 16/332,804

(22) PCT Filed: Sep. 14, 2017
(86) PCT No.: PCT/EP2017/073152

§ 371 Date: Mar. 13, 2019

(30) Foreign Application Priority Data
Sep. 14, 2016 (GB) 1615579.8

(51) Int. Cl. F16J 15/10; F16J 15/12; F16L 21/02; F16L 23/028; F16L 23/18

(52) U.S. Cl. CPC F16J 15/104; F16J 15/121; F16L 23/18; F16L 23/0283; F16L 21/02

(57) ABSTRACT

A seal, in particular for a fluid line connector, includes: a tubular body with an inner surface, an outer surface, a first axial end, and a second axial end; a first elastomeric layer arranged on the inner surface; and a second elastomeric layer arranged on the outer surface. In an embodiment, the first elastomeric layer extends over the first axial end of the tubular body and merges into the second elastomeric layer.

### CROSS-REFERENCE TO PRIOR APPLICATIONS

This application is a U.S. National Phase application under 35 U.S.C. § 371 of International Application No. PCT/EP2017/073152, filed on Sep. 14, 2017, and claims benefit to British Patent Application No. GB 1615579.8, filed on Sep. 14, 2016. The International Application was published in English on Mar. 22, 2018 as WO 2018/050752 under PCT Article 21(2).

### FIELD

The invention relates to a seal, in particular for a fluid line end connector for example arranged on one end or both end of a fluid line. A fluid line end connector is used to connect a fluid line with a system component.

### BACKGROUND

Such a seal is for example used in air conditioning systems to seal an end connection of a fluid line to a system component, such as a condenser, pump or expansion valve.

The known seals, which are typically washer shaped, are positioned between two flanges to which the ends of fluid lines are connected. These flanges are bolted together to clamp the seal between the flanges. A sufficient axial force, with respect to the direction of the fluid line, needs to be exerted on the seal in order to have a sufficient sealing function.

To this end, the flanges are typically of a metal, such as steel or aluminum, which does not deform much, when the flanges are bolted together. However, in particular in automotive applications, it is desired to reduce the weight of the fluid lines as much as possible. One choice would be to manufacture the fluid lines of plastic, in particular thermoplastic, which in view of the known metal, reduces the weight significantly.

However, a disadvantage of using thermoplastic is the viscoelasticity of thermoplastic. When the flanges of a known fluid line connection would be made out of thermoplastic material, the flanges present lower resistance to the torque force when the parts are bolted together, such that not a sufficient axial force can be applied to the washer type seal from the prior art. So, no sufficient sealing would be obtained.

When the flanges would be designed in thermoplastic more rigidly and more stiff, in order to be able to sustain sufficient axial force, then the flanges would become bulky. The oversized flanges would require additional space, which is in automotive applications often not available or applicable due to packaging constraints, and the additional material to improve the strength to the plastic flange will adversely affect the weight. It would also be possible to use stronger thermoplastics, such as PEEK, but this would increase the costs excessively.

### SUMMARY

In an embodiment, the present invention provides a seal, in particular for a fluid line connector, comprising: a tubular body with an inner surface, an outer surface, a first axial end, and a second axial end; a first elastomeric layer arranged on the inner surface; and a second elastomeric layer arranged on the outer surface.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows an exploded perspective view of an embodiment of a combination according to the invention.

FIG. 2A shows a cross sectional view of the seal according to the invention and according to FIG. 1.

FIG. 2B shows a cross sectional view of the combination of FIG. 1 in assembled state.

### DETAILED DESCRIPTION

In an embodiment, the present invention provides a seal that reduces the above mentioned disadvantages in order to make the use of plastic flanges more viable.

In an embodiment, the present invention provides a seal, in particular for a fluid line end connector, comprising:
a tubular body with an inner surface, an outer surface, a first axial end and a second axial end;
a first elastomeric layer arranged on the inner surface; and
a second elastomeric layer arranged on the outer surface.

The seal according to the invention is tubular shaped in contrast to the washer shaped seals of the prior art. The seal according to the invention is to be arranged between two fluid line ends, which are inserted in to each other, similar to a telescopic arrangement. As a result, the sealing will be provided in a radial direction, between the outer circumferential surface of a first fluid line and the inner circumferential surface of a second fluid line. So, the force required for the sealing is radially directed and no longer in axial direction as with the prior art seals. A radial sealing force is easily obtained by dimensioning both fluid line ends and the seal.

By using a tubular body on which the first and second elastomeric layers are arranged, the tubular body provides a rigid support to the elastomeric layers, such that the seal can easily be inserted into a fluid line end or over a fluid line end, without overstretching the elastomeric material.

Also pressure differences over the elastomeric layers can be resisted as the layers are attached to the tubular body and typically are also restricted in radial direction. Thus, the tubular body ensures that the first and second elastomeric layers maintain their position and general shape when being mounted and in use. As a result, complex grooves in the end connector of the fluid line are no longer required. This advantage allows for plastic, in particular thermoplastic, fluid line end connections to be used, and which do not suffer from flash by the contact of the elastomeric layer on this surfaces, because these surfaces can be made using a single mould surface, which prevents the occurrence of flash on these surfaces. A seamless surface provides for low permeation sealings when using thermoplastic components.

The tubular body should be rigid in respect with the elastomeric material of the layers. Therefore, the tubular body could be of metal or a non-elastic plastic, such as a non-elastic thermoplastic (PA-PP) or a reinforced thermoplastic (PA-CF or PA-GF) or high performance thermoplastics (PEEK or High Strength PP).

In a preferred embodiment of the seal according to the invention the first elastomeric layer extends over the first axial end of the tubular body and merges into the second elastomeric layer.

Because the elastomeric layer runs over the first axial end, the seal can be slid more easily into a female end connection of a fluid line or female component connection. The continuous and flexible elastomeric layer reduces the friction, while also a continuous and non-interrupted sealing layer is provided between the two surfaces of the end connection of the fluid line or component connection.

In a further embodiment of the seal according to the invention the second elastomeric layer is provided with at least one circumferential ridge.

In a further preferred embodiment of the seal according to the invention the first elastomeric layer comprises at least one radially inward directed circumferential lip.

Due to the elastic properties of the elastomeric material, the elastomeric layers can easily be provided with ridges and lips to further improve the sealing action of the seal. The provision of such ridges and lips does not require complex moulds as after moulding the layers, due to the elasticity of the material, this elastomeric material can easily be released from the moulds.

Preferably, the at least one circumferential lip is arranged on an axial end of the first elastomeric layer. The lip provides for an additional seal relative to the male fluid line end connection, which is inserted into the seal.

In a further embodiment, the radially inward directed circumferential lip is bendable outwards so it can be entirely retracted from an inner lumen defined by first elastomeric layer. In other words, the inner diameter of the first elastomeric layer can be constant in the axial direction.

In another embodiment the seal comprises a second radially inward directed circumferential lip which is arranged on the other axial end of the first elastomeric layer. Preferably, the second radially inward directed circumferential lip is bendable outwards so it can be entirely retracted from an inner tubular lumen defined by first elastomeric layer.

In another preferred embodiment of the seal according to the invention the tubular body comprises a radially outward directed flange arranged on the second axial end.

The outward directed flange ensures that the seal can be inserted into a hole up to the length of the seal. When a second fluid line end is inserted into the seal, the flange prevents the seal from being shifted further into the hole.

In yet a further preferred embodiment of the seal according to the invention the second elastomeric layer extends over a first section of the tubular body and wherein the first section of the tubular body has a reduced diameter with respect to a second section of the tubular body, such that the outer diameter of the second elastomeric layer equals the outer diameter of the second section.

Due to the stepped diameter of the tubular body, the hole, in which the seal is inserted can both be used to center the tubular body with the larger diameter section and be used to provide a seal with the elastomeric layer arranged on the smaller diameter section of the tubular body.

In still a further preferred embodiment of the seal according to the invention the tubular body is cylindrical. A cylindrical shape provides for an optimal strength in radial direction as well as an even distribution along the circumference.

Preferably, the first and second elastomeric layers are fused to the tubular body. By fusing the elastomeric layers to the tubular body a strong attachment is provided of the layers to the body, which contributes to the robustness of the seal.

The invention further relates to a combination of a seal according to the invention and a fluid line connector comprising a male connector part and a female connector part, wherein the male connector part comprises a body with a tubular extension and wherein the female connector part comprises a body with an opening, wherein the seal is coaxially arranged in the opening and wherein the tubular extension of the male connector part is coaxially arranged in the seal, and wherein the fluid line connector further comprises a mounting device for mounting the male connector part and female connector part together.

With the combination, the fluid line ends are provided by the male and female connector parts, which can be mated with the interposition of the seal according to the invention.

Preferably, the outer dimensions of the seal correspond with the inner dimensions of the hole in the female connector part and wherein the inner dimensions of the seal correspond with the outer dimensions of the tubular extension.

Depending on the required radial force on the seal, the dimensions of the seal and of the connector parts are chosen to be either identical or such that the elastomeric layers need to be compressed to mount the connector parts and the seal.

It is furthermore preferred if the male connector part and female connector part are of plastic. In particular in automotive applications, the use of plastic reduces weight and due to the radial sealing of the seal according to the invention, no excessive material is required to obtain sufficient strength, as would be the case with the washer type of seals according to the prior art.

It is also preferred if the combination is in the mounted state a radially inward directed circumferential lip comprised by the seal is bent outwards and entirely retracted from an inner lumen defined by first elastomeric layer.

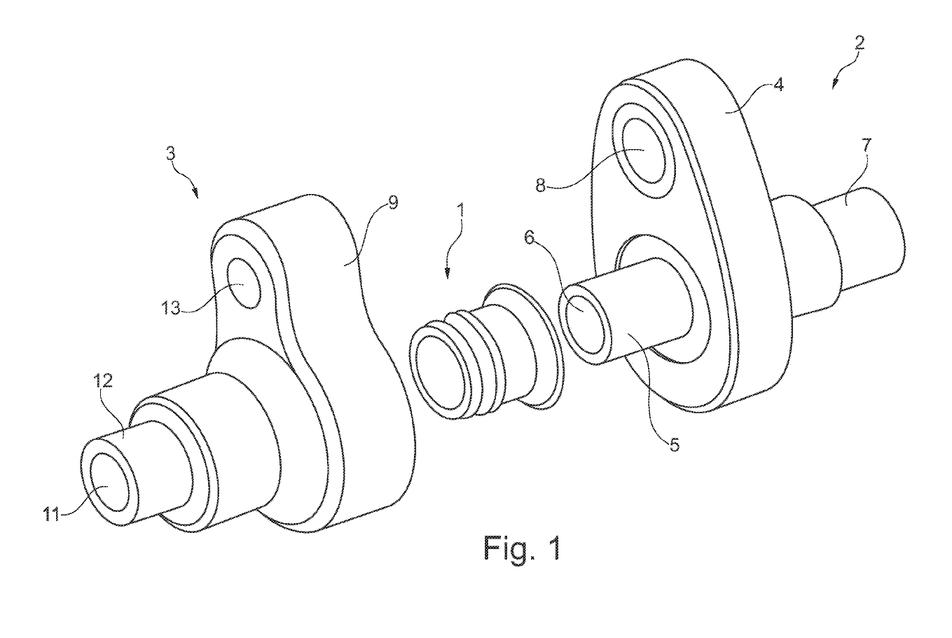

FIG. 1 shows a combination according to the invention with a seal 1 and a fluid line connector with a male connector part 2 and a female connector part 3.

The male connector part 2 has a body 4 with a tubular extension 5 with a channel 6, which connects to the fluid line 7. The body 4 has furthermore a mounting hole 8 with which the male connector part 2 can be mounted to the female connector part 3.

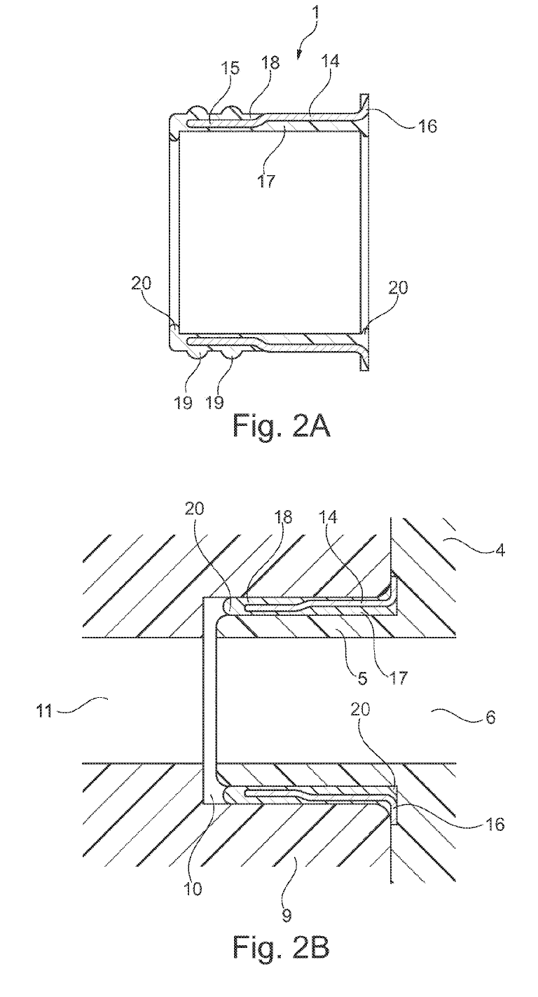

The female connector part 3 also has a body 9 with a hole 10 (see FIG. 2B). A channel 11 debouches in this hole and the channel 11 connects to a fluid line 12. The body 9 also has a mounting hole 13 for cooperation with the mounting hole 8 of the male connector part 2.

FIG. 2 shows the seal 1 in cross sectional view. The seal 1 has a tubular body 14, 15, 16 of preferably metal or a rigid plastic. The tubular body 14, 15, 16 has a first section 14 with a reduced diameter with respect to the diameter of a second section 15. Furthermore, the tubular body 14, 15, 16 is provided with an outwardly directed flange 16.

A first elastomeric layer 17 is arranged on the inner surface of the tubular body 14, 15, 16. This first elastomeric layer 17 runs along a first axial end of the tubular body 14, 15, 16 and merges into a second elastomeric layer 18, which is arranged on the outer surface of the tubular body 14, 15, 16. This second elastomeric layer 18 is only arranged over the first section 15 with reduced diameter, such that the outer diameter of the second elastomeric layer 18 equals the outer diameter of the second section 14.

The second elastomeric layer 18 is furthermore provided with two circumferential ridges 19, while the first elastomeric layer 17 is on both axial ends provided with radially inwardly directed lips 20.

FIG. 2B shows a cross sectional view of the combination of FIG. 1 in mounted state. The seal 1 is positioned on the tubular extension 5 of the male connector part 2, such that the first elastomeric layer 17 is pressed sealingly on the outer circumferential surface of the tubular extension 5.

The male connector part 2 with the seal 1 is inserted into the hole 10 of the female connector part 3, such that the second elastomeric layer 18 is pressed to the inward circumferential surface of the hole 10. The second section 14 has the same outer diameter as the inner diameter of the hole 10, such that the seal 1 is centered in this hole 10.

The flange 16 of the seal 1 is embedded in a groove in the body 4 of the male connector part 4, such that the bodies 4, 9 of both connector parts 2, 3 can be mounted flush against each other, while the flange 16 prevents the seal 1 from being shifted further into the hole 10.

FIG. 28 also shows that the radially inward directed circumferential lip 20 at the first axial end of the first elastomeric layer 17 (left side) is bent outwards and is entirely retracted from an inner lumen defined by first elastomeric layer 17.

Likewise, the second radially inward directed circumferential lip 20 arranged on the other axial right end of the first elastomeric layer 17 is bent outwards and is entirely retracted from the inner lumen defined by first elastomeric layer 17.

The inner diameter of the first elastomeric layer 17 is overall constant in the axial direction of the seal 1. Also, the outer diameter of the outer circumferential surface of the tubular extension 5 is, over the whole axial length, equal to the inner diameter of the first elastomeric layer 17.

Therefore, in the mounted state, the radially inward directed circumferential lips 20 comprised by the seal 1 are bent (or pressed) outwards and entirely retracted from the inner lumen defined by first elastomeric layer 17. Preferably an axial gap between the axial (distant) end of the tubular extension 5 and the body 9 of the female connector part 3 is free of the circumferential lip 20.

Both the connector parts 2, 3 are preferably made of a plastic, such that for example weight can be reduced.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A seal, in particular for a fluid line connector, comprising:
a tubular body with an inner surface, an outer surface, a first axial end, and a second axial end;
a first elastomeric layer arranged on the inner surface; and
a second elastomeric layer arranged on the outer surface.

2. The seal according to claim 1, wherein the first elastomeric layer extends over the first axial end of the tubular body and merges into the second elastomeric layer.

3. The seal according to claim 1, wherein the second elastomeric layer comprises at least one circumferential ridge.

4. The seal according to claim 1, wherein the first elastomeric layer comprises at least one radially inward directed circumferential lip.

5. The seal according to claim 4, wherein the at least one radially inward directed circumferential lip is arranged on an axial end of the first elastomeric layer.

6. The seal according to claim 4, wherein the at least one radially inward directed circumferential lip is bendable outwards or compressible outwards so as to be entirely retracted from an inner lumen defined by first elastomeric layer.

7. The seal according to claim 4, wherein a second radially inward directed circumferential lip is arranged on an other axial end of the first elastomeric layer.

8. The seal according to claim 1, wherein the tubular body comprises a radially outward directed flange arranged on the second axial end.

9. The seal according to claim 1, wherein the second elastomeric layer extends over a the tubular body, and
wherein a first section of the tubular body has a reduced diameter with respect to a second section of the tubular body, such that an outer diameter of the second elastomeric layer equals an outer diameter of the second section.

10. The seal according to claim 1, wherein the tubular body is cylindrical.

11. The seal according to claim 1, wherein the first and second elastomeric layers are fused to the tubular body.

12. A combination, comprising:
the seal according to claim 1; and
a fluid line connector comprising a male connector part and a female connector part, the male connector part comprising a body with a tubular extension and the female connector part comprising a body with an opening,
wherein the seal is coaxially arranged in the opening,
wherein the tubular extension of the male connector part is coaxially arranged in the seal, and
wherein the fluid line connector further comprises a mounting device configured to mount the male connector part and female connector part together.

13. The combination according to claim 12, wherein outer dimensions of the seal correspond with inner dimensions of a hole in the female connector part, and
wherein inner dimensions of the seal correspond with outer dimensions of the tubular extension.

14. The combination according to claim 12, wherein the male connector part and female connector part are comprised of plastic.

15. The combination according to claim 12, wherein, in a mounted state, a radially inward directed circumferential lip comprised by the seal is bent or compressed outwards and entirely retracted from an inner lumen defined by first elastomeric layer.
